(19) United States
(12) Patent Application Publication
(10) Pub. No.: US 2012/0314768 A1
(43) Pub. Date: Dec. 13, 2012

(54) METHOD AND DEVICE FOR ENCODING/DECODING A PREDICTION IMAGE IN A LAYERED CODING STRUCTURE

(75) Inventors: Min-Woo Park, Yongin-si (KR); Dae-Hee Kim, Suwon-si (KR); Jae-Woo Jung, Cheonan-si (KR); Dae-Sung Cho, Seoul (KR)

(73) Assignee: SAMSUNG ELECTRONICS CO., LTD., Suwon-si (KR)

(21) Appl. No.: 13/580,873

(22) PCT Filed: Feb. 23, 2011
(86) PCT No.: PCT/KR2011/001276

§ 371 Date: Aug. 23, 2012

Related U.S. Application Data
(60) Provisional application No. 61/282,511, filed on Feb. 23, 2010.

(51) Int. Cl. H04N 7/32

(52) U.S. Cl. 375/240.13; 375/240.12; 375/E07.243; 375/E07.125

(57) ABSTRACT

There is provided a method and apparatus for efficiently coding/decoding pictures in a layered coding structure. The method for decoding pictures in a layered coding structure includes determining a block mode of a target block for which a prediction picture is to be generated, from a received block-based bitstream; and generating the prediction picture based on the determined block mode and peripheral block information including picture type information for a peripheral block of the target block.

### CROSS-REFERENCE TO RELATED APPLICATIONS

This application is a National Phase Entry of PCT International Application No. PCT/KR2011/001276, which was filed on Feb. 23, 2011, and claims priority to a U.S. Provisional Application No. 61/282,511 filed in the United States Patent and Trademark Office on Feb. 23, 2010, the entire disclosures of which are incorporated herein by reference.

### BACKGROUND

1. Field

The present invention relates to a picture coding method and apparatus, and more particularly, to a method and apparatus for coding/decoding prediction pictures in a direct mode and a skip mode.

2. Description of Related Art

In video coding technology, many studies have been conducted on various schemes that use prediction pictures during video coding. Related technology for generating prediction pictures during video coding/decoding will be described below in brief.

Generally, video compression technology for generating prediction pictures is well known in H.264 and the like. As regards the generation of prediction pictures during coding/decoding in H.264, the general skip mode and direct mode will be described as follows.

First, the skip mode derives motion information from peripheral blocks, and generates prediction pictures (or blocks) using the derived motion information, without coding/decoding motion information or residual picture information. In a decoding process, generated prediction pictures (or blocks) refer to decoded blocks. The direct mode derives motion information from peripheral blocks, generates prediction pictures (or blocks) using the derived motion information, and adds them to received residual pictures to generate decoded picture blocks. The direct mode does not encode/decode motion information. The difference between the skip mode and the direct mode lies in whether residual picture blocks are transmitted or not. The direct mode transmits residual picture blocks. The skip mode and the direct mode are the same in the method of deriving motion information.

As described above, in coding/decoding of prediction pictures, the direct mode and skip mode derive motion information from peripheral blocks of prediction picture blocks to be coded, without coding/decoding the motion information, and generate prediction picture blocks by motion compensation that uses the derived motion information, and the direct mode additionally encodes/decodes residual data obtained by computing differentials between original picture blocks and prediction picture blocks.

An example of a prediction picture coding/decoding method in the direct mode and skip mode may include a direct mode and skip mode coding/decoding method of H.264 Scalable Video Coding (SVC). Actually, the direct mode and skip mode of H.264 SVC are the same in the method of generating prediction pictures by deriving motion information. Generally, in the direct mode and skip mode of H.264 SVC, coding/decoding of prediction pictures is achieved in the actual picture area. However, in the layered coding structure for maintaining compatibility with any video codecs, a prediction coding/decoding scheme is required that considers residual pictures, since the layered coding structure uses residual pictures.

### SUMMARY

An aspect of an exemplary embodiment of the present invention is to provide a method and apparatus for efficiently coding/decoding prediction pictures in a layered coding structure.

Another aspect of an exemplary embodiment of the present invention is to provide a method and apparatus for coding/decoding prediction pictures to be suitable for residual pictures in a direct mode and a skip mode of a layered coding structure.

Another aspect of an exemplary embodiment of the present invention is to provide a bidirectional prediction coding/decoding method and apparatus suitable for residual pictures in a direct mode and a skip mode of a layered coding structure.

### Technical Solution

In accordance with one aspect of the present invention, there is provided a method for coding a picture in a layered coding structure. The method includes determining a block mode of a target block for which a prediction picture for coding of an input original picture is to be generated; and generating the prediction picture based on the determined block mode and peripheral block information including picture type information for a peripheral block of the target block.

In accordance with another aspect of the present invention, there is provided an apparatus for coding a picture in a layered coding structure. The apparatus includes a block mode determiner for determining a block mode of a target block for which a prediction picture for coding of an input original picture is to be generated; and a prediction picture generator for generating the prediction picture based on the determined block mode and peripheral block information including picture type information for a peripheral block of the target block.

In accordance with further another aspect of the present invention, there is provided a method for decoding a picture in a layered coding structure. The method includes determining a block mode of a target block for which a prediction picture is to be generated, from a received block-based bitstream; and generating the prediction picture based on the determined block mode and peripheral block information including picture type information for a peripheral block of the target block.

In accordance with yet another aspect of the present invention, there is provided an apparatus for decoding a picture in a layered coding structure. The apparatus includes a block mode determiner for determining a block mode of a target block for which a prediction picture is to be generated, from a received block-based bitstream; and a prediction picture generator for generating the prediction picture based on the determined block mode and peripheral block information including picture type information for a peripheral block of the target block.

### BRIEF DESCRIPTION OF THE DRAWINGS

FIG. 1 is a flowchart showing a method for generating prediction pictures in a direct mode and a skip mode that use a layered coding structure according to an embodiment of the present invention;

FIG. 2 is a block diagram showing a structure of a picture coding apparatus according to an embodiment of the present invention; and

FIG. 3 is a block diagram showing a structure of a picture decoding apparatus according to an embodiment of the present invention.

### DETAILED DESCRIPTION

An embodiment of the present invention provides a method that is more suitable for a residual picture area, because it is for coding/decoding of a direct mode and a skip mode in residual pictures.

It should be noted that an embodiment of the present invention may be applied to video coding/decoding technology in various different layered structures including, for example, VC-4.

Operations of the skip mode and direct mode provided by an embodiment of the present invention will be described. In the present invention, the skip mode and direct mode operate in different ways depending on the mode in which peripheral blocks are encoded.

-Operation of Skip Mode

If peripheral blocks A (left block) and B (above block) are outside an intra mode or a picture area, the skip mode fully fills the target blocks, prediction pictures for which are to be determined, with ‘0’, without performing prediction (e.g., motion compensation). In this case, the picture blocks decoded by a decoder are blocks which are fully filled with ‘0’ (motion information and residual picture information are not coded). Otherwise, if the peripheral blocks are within an inter mode or a picture area, the skip mode derives motion information from peripheral blocks, and then generates prediction pictures (blocks) using the derived motion information. This is also an operation performed in the skip mode (motion information and residual picture information are not coded).

-Operation of Direct Mode

If peripheral blocks A (left block) and B (above block) are outside an intra mode or a picture area, the direct mode generates prediction pictures (blocks) by defining motion information (e.g., motion vectors) as ‘0’, and adds them to received residual picture blocks to generate decoded picture blocks (motion information is not coded). Otherwise, the direct mode derives motion information from the peripheral blocks, generates prediction pictures (blocks) using the derived motion information, and adds them to received residual picture blocks to generate decoded picture blocks. This is also an operation performed in the direct mode (motion information is not coded).

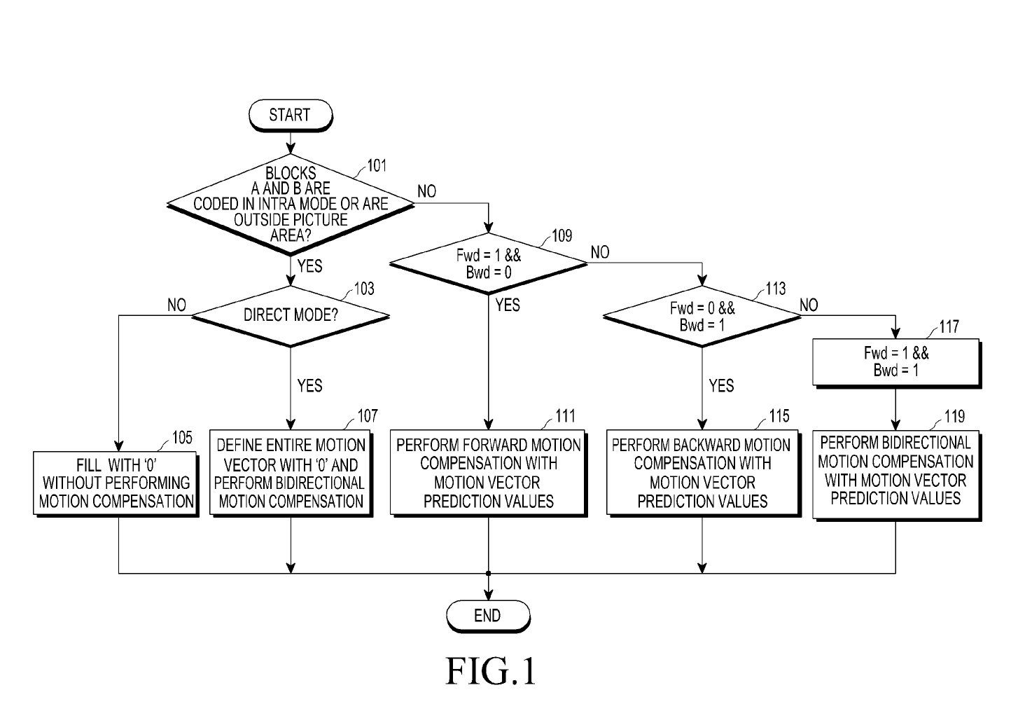

FIG. 1 is a flowchart showing a method for generating prediction pictures in a direct mode and a skip mode that use a layered coding structure according to an embodiment of the present invention. The prediction picture generation method shown in FIG. 1 may be applied to coding and decoding in the same way.

Although it is assumed in FIG. 1 that the current block means a target block, prediction pictures for which are to be generated, and the peripheral blocks are, for example, a left block (block A) and an above block (block B), the peripheral blocks are not limited thereto, and various other blocks may be used as the peripheral blocks. The term ‘block’ as used herein may refer not only to a macro block which is the basic unit in image processing, but also to other image blocks having different sizes.

Referring to FIG. 1, if the left block (block A) and above block (block B) of the current block are coded in the intra mode or are outside the picture area in step 101, the method proceeds to step 103. Otherwise, the method proceeds to step 109. If the mode is not the direct mode (i.e., is the skip mode) in step 103, the method proceeds to step 105. Mode determination during coding may be performed by the conventional scheme of determining the optimal mode. Mode determination during decoding may determine any one of the direct mode and the skip mode based on the information included, for example, in header information of a macro block according to the conventional scheme. Generally, header information of a macro block may include mode-related information used for image processing, such as direct mode, skip mode, intra mode and inter mode.

If the left block (block A) and above block (block B) of the current block are coded in the intra mode or are outside the picture area in step 103, an operation (step 105) of the skip mode is different from an operation (step 107) of the direct mode, as shown in the decision step 103 of FIG. 1.

However, if the left block (block A) and above block (block B) of the current block are coded in the inter mode or are within the picture area in step 103, the skip mode and the direct mode are the same in operation. Therefore, the decision operation of step 103 is not required in operations of steps 109 to 119.

In step 105, the method fills a prediction picture with ‘0’ without performing motion compensation. If the mode is the direct mode in step 103, the method defines the entire motion vector as ‘0’ and performs bidirectional motion compensation thereon to generate a prediction picture, in step 107.

If the peripheral blocks of the current block have undergone only forward prediction and have not undergone backward prediction in step 109 (Fwd=1 && Bwd=0), the method proceeds to step 111. Otherwise, the method proceeds to step 113. In step 111, the method performs forward motion compensation with a forward motion vector prediction value to generate a prediction picture.

If the peripheral blocks of the current block have undergone only backward prediction and have not undergone forward prediction in step 113 (Fwd=0 && Bwd=1), the method proceeds to step 115. Otherwise, the method proceeds to step 117. In step 115, the method performs backward motion compensation with a backward motion vector prediction value to generate a prediction picture.

Step 117 corresponds to a case where the peripheral blocks of the current block have undergone both forward and backward predictions (Fwd=1 && Bwd=1). In step 119, the method performs bidirectional motion compensation with forward and backward motion vector prediction values to generate a prediction picture.

A conventional scheme may be used as the scheme shown FIG. 1 and determining forward and backward motion vector prediction values and performing motion compensation to generate prediction pictures.

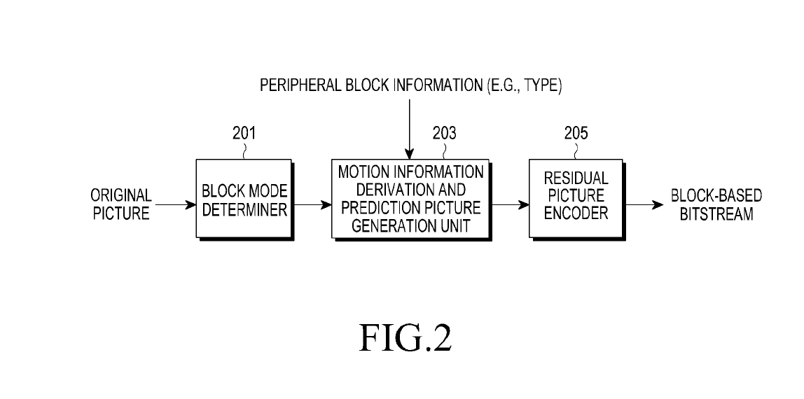

FIG. 2 is a block diagram showing a structure of a picture coding apparatus according to an embodiment of the present invention. The coding apparatus shown in FIG. 2 generates prediction pictures in accordance with the method of FIG. 1 in each of the skip mode and the direct mode.

In FIG. 2, a block mode determiner 201 determines a block mode during coding of an input original picture. As a block mode, at least one mode applied during image processing is determined, such as the skip mode, direct mode, intra mode and inter mode. For a mode appropriate for each block, a scheme known in video coding technology is used, so a detailed description thereof will be omitted. A motion information derivation and prediction picture generation unit 203 generates prediction pictures based on peripheral block information and a block mode (skip mode or direct mode) in accordance with the method of FIG. 1. The peripheral block information, picture type-related information, includes information indicating whether the peripheral blocks are in the intra mode or the inter mode, or whether the peripheral blocks are outside or inside the picture area, as described in conjunction with FIG. 1. A residual picture encoder 205 encodes residual pictures obtained by computing differentials between the original pictures and the prediction pictures, and outputs a block-based bitstream. The motion information derivation and prediction picture generation unit 203 is enabled in the direct mode or the skip mode to derive motion information and generate prediction pictures based on the derived motion information. The residual picture encoder 205 is enabled in the direct mode.

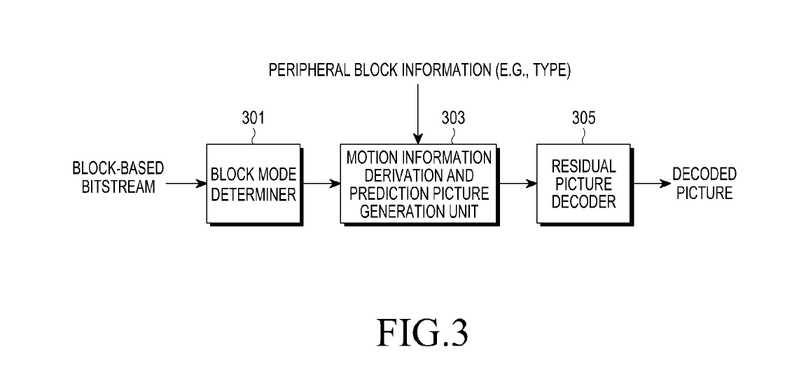

FIG. 3 is a block diagram showing a structure of a picture decoding apparatus according to an embodiment of the present invention. The decoding apparatus shown in FIG. 3 generates prediction pictures in each of the skip mode and the direct mode in accordance with the method of FIG. 1.

In FIG. 3, a block mode determiner 301 determines a block mode of an input block-based bitstream. Information about the block mode may be transferred to the decoding apparatus by being included in header information of a related block (e.g., header information of a macro block). A motion information derivation and prediction picture generation unit 303 generates prediction pictures based on peripheral block information and a block mode (skip mode or direct mode) in accordance with the method of FIG. 1. The peripheral block information, picture type-related information, includes information indicating whether the peripheral blocks are in the intra mode or the inter mode, or whether the peripheral blocks are outside or inside the picture area, as described in conjunction with FIG. 1. A residual picture decoder 305 decodes residual pictures, and then adds them to prediction pictures to output decoded pictures. The motion information derivation and prediction picture generation unit 303 is enabled in the direct mode or the skimp mode to derive motion information and generate prediction pictures based on the derived motion information. The residual picture decoder 305 is enabled in the direct mode.

Table 1 to Table 4 below show syntaxes when an embodiment of the present invention is applied, for example, to VC-4 video coding technology, and Table 5 to Table 7 below show definitions of details related to bidirectional prediction in the operation of FIG. 2 when an embodiment of the present invention is applied to VC-4 video coding technology.

TABLE 1
B-picture Flag (B_PICTURE_FLAG) (1 bit)
The syntax element B_PICTURE_FLAG, when set to 1, indicates that
the current frame is coded as a bidirectionally predictive-coded picture
(B picture). If B_PICTURE_FLAG == 0, the current frame is coded as a
P picture.

TABLE 2
Predictive Direction for P Picture (PRED_DIRECTION) (1 bit)
The syntax element PRED_DIRECTION indicates the temporal direction
of the motion compensated prediction for P-picture. If
PRED_DIRECTION is set to 0, a past picture is selected as a reference
frame for the current picture. Otherwise, a future picture is selected as a
reference frame.

TABLE 3
Skipped-macroblock Run (SKIP_RUN) (variable size)
The syntax element SKIP_RUN specifies how many macroblocks are
skipped. This value is from zero to four. SKIP_RUN is decoded using
adaptive VLC code. If the number of skipped macroblocks is greater than
four, SKIP_RUN shall be repeated until all skipped macroblocks are
counted. The skipped macroblocks described by SKIP_RUNs are
not decoded.

TABLE 4
Prediction Mode for B picture (B_PRED_MODE) (2 bits)
The syntax element B_PRED_MODE specifies the prediction mode
when the current picture is coded with one or more motion vectors in the
B picture. B_PRED_MODE shall be coded according to the below
table (Meaning of B_PRED_MODE). In the direct mode (when
B_PRED_MODE == DIRECT_MODE), the prediction for the
current macroblock shall be obtained using motion vectors of neighboring
blocks/macroblocks without motion vectors of the current macroblock.
In the forward mode (when B_PRED_MODE == FORWARD_MODE)
or the backward mode (when B_PRED_MODE ==
BACKWARD_MODE), the prediction for the current macroblock
shall be obtained in the same way as the P picture coding. This mode also
supports the motion vector scaling when the current picture is coded as a
field picture.
In the interpolated mode (when B_PRED_MODE ==
INTERPOLATED_MODE), the forward and the backward motion
vectors shall be explicitly coded within the bitstream and the prediction
for the current macroblock shall be interpolated from the two reference
pictures. The interpolation operation in this mode shall be pixel-wise
average operation with the two referenced pictures. If the current
macroblock is coded with 1-MV mode, 2 motion vectors, each of which
points to the macroblocks each reference frame, shall be used for
interpolation. If the current macroblock is coded with 4-MV mode, 8
motion vectors shall be used and each 4 motion vectors points to
the 4 blocks of each reference frame.

Meaning of B_PRED_MODE

| B_PRED_MODE | MB Prediction Mode |
|---|---|
| 0 | DIRECT_MODE |
| 1 | FORWARD_MODE |
| 2 | BACKWARD_MODE |
| 3 | INTERPOLATED_MODE |

TABLE 5
Skipped-macroblock Run (SKIP_RUN)
the skipped macroblocks are compensated with the predicted motion
vector from neighboring macroblocks in the inter frame.
In the B picture coding, the number of the predicted motion vectors is
one or two. If some of neighboring macroblocks have forward motion
vectors, the forward-predicted motion vector shall be derived from those
forward motion vectors. Similarly, if some of neighboring macroblocks
have backward motion vectors, the backward-predicted motion vector
shall be derived from those backward motion vectors.

TABLE 6
Direct mode for B picture
The direct mode shall be selected for decoding the current macroblock
whenever B_PRED_MODE == 0 and B_PICTURE_FLAG == 1.
This mode shall not use the explicitly coded motion vectors but use the
predicted motion vectors. There are four cases for prediction for the
current macroblock depending on the motion vector prediction.
If all of the neighboring macroblocks have only forward motion vectors,
the current macroblock is compensated with only the forward-predicted
motion vector.
If all of the neighboring macroblocks have only backward motion vectors,
the current macroblock is compensated with only the backward-predicted
motion vector.
If both the forward-predicted motion vector and the backward-predicted
motion vector exist, the current macroblock is compensated with the
interpolated macroblock from both the forward-predicted and the
backward-predicted motion vector. The interpolated macroblock shall be
made using equation of <table 7>.
If the above and left blocks of the current macroblock are coded in intra
mode or outside frame, Both the forward-predicted motion vector and the
backward-predicted motion vector are set to zeros. The current macroblock
is compensated with these zero motion vectors. The interpolated
macroblock shall be made using equation of <table 7>.
Unlike the skip mode, this mode shall use the transmitted transform
coefficients with the compensated data to reconstruct residuals

TABLE 7
Interpolated mode for B Picture
The interpolated mode shall be selected for decoding the current
macroblock whenever B_PRED_MODE == 3 and
B_PICTURE_FLAG == 1. This mode shall use two explicitly-coded
motion vectors for the motion compensation. One motion vector points
to a past reference picture and the other one points to a future reference
picture. Each prediction shall be performed with each motion vector to
each reference frame. The interpolation from each prediction shall be
a pixel average operation with round-up to compute the pixels in the
motion compensated macroblock
<equation>
I(x, y) = (P1(x, y) + P2(x, y) + 1) >> 1
where I(x, y) is the interpolated pixel from both predicted macroblocks,
P1(x, y) is the pixel of the first predicted macroblock, and P2(x, y) is
the pixel of the second predicted macroblock.

1-2. (canceled)

3. A method for coding a picture in a layered coding structure, comprising:
determining a block mode of a target block for which a prediction picture for coding of an input original picture is to be generated; and
generating the prediction picture based on the determined block mode and peripheral block information including picture type information for a peripheral block of the target block.

4. The method of claim 3, further comprising coding a residual picture corresponding to a differential picture between the original picture and the prediction picture, if the block mode is a direct mode.

5. The method of claim 3, wherein the block mode includes at least one of a direct mode and a skip mode, and operations of the direct mode and the skip mode are determined depending on a picture type of the peripheral block.

6. The method of claim 3, wherein the peripheral block information includes at least one of information indicating whether a mode, in which the peripheral block is coded, is an intra mode or an inter mode, and information indicating whether the peripheral block exists outside or inside a picture area.

7. The method of claim 6, wherein generating the prediction picture comprises fully filling the prediction picture with ‘0’ without performing motion compensation, if the block mode is a skip mode and the peripheral block information indicates the intra mode or indicates that the peripheral block exists outside the picture area.

8. The method of claim 6, wherein generating the prediction picture comprises fully setting a motion vector with ‘0’ and generating the prediction picture by performing bidirectional motion compensation, if the block mode is a direct mode and the peripheral block information indicates the intra mode or indicates that the peripheral block exists outside the picture area.

9. An apparatus for coding a picture in a layered coding structure, comprising:
a block mode determiner for determining a block mode of a target block for which a prediction picture for coding of an input original picture is to be generated; and
a prediction picture generator for generating the prediction picture based on the determined block mode and peripheral block information including picture type information for a peripheral block of the target block.

10. The apparatus of claim 9, further comprising a residual picture encoder for coding a residual picture corresponding to a differential picture between the original picture and the prediction picture, if the block mode is a direct mode.

11. The apparatus of claim 9, wherein the block mode includes at least one of a direct mode and a skip mode, and operations of the direct mode and the skip mode are determined depending on a picture type of the peripheral block.

12. The apparatus of claim 7, wherein the peripheral block information includes at least one of information indicating whether a mode, in which the peripheral block is coded, is an intra mode or an inter mode, and information indicating whether the peripheral block exists outside or inside a picture area.

13. The apparatus of claim 12, wherein the prediction picture generator fully fills the prediction picture with ‘0’ without performing motion compensation, if the block mode is a skip mode and the peripheral block information indicates the intra mode or indicates that the peripheral block exists outside the picture area.

14. The apparatus of claim 12, wherein the prediction picture generator fully sets a motion vector with ‘0’ and generates the prediction picture by performing bidirectional motion compensation, if the block mode is a direct mode and the peripheral block information indicates the intra mode or indicates that the peripheral block exists outside the picture area.

15. A method for decoding a picture in a layered coding structure, comprising:
determining a block mode of a target block for which a prediction picture is to be generated, from a received block-based bitstream; and
generating the prediction picture based on the determined block mode and peripheral block information including picture type information for a peripheral block of the target block.

16. The method of claim 15, further comprising, if the block mode is a direct mode, receiving a residual picture corresponding to a differential picture between an original picture and the prediction picture, and restoring the original picture by adding the residual picture to the prediction picture.

17. The method of claim 15, wherein the block mode includes at least one of a direct mode and a skip mode, and operations of the direct mode and the skip mode are determined depending on a picture type of the peripheral block.

18. The method of claim 15, wherein the peripheral block information includes at least one of information indicating whether a mode, in which the peripheral block is coded, is an intra mode or an inter mode, and information indicating whether the peripheral block exists outside or inside a picture area.

19. The method of claim 18, wherein generating the prediction picture comprises fully filling the prediction picture with ‘0’ without performing motion compensation, if the block mode is a skip mode and the peripheral block information indicates the intra mode or indicates that the peripheral block exists outside the picture area.

20. The method of claim 18, wherein generating the prediction picture comprises fully setting a motion vector with ‘0’ and generating the prediction picture by performing bidirectional motion compensation, if the block mode is a direct mode and the peripheral block information indicates the intra mode or indicates that the peripheral block exists outside the picture area.

21. An apparatus for decoding a picture in a layered coding structure, comprising:
a block mode determiner for determining a block mode of a target block for which a prediction picture is to be generated, from a received block-based bitstream; and
a prediction picture generator for generating the prediction picture based on the determined block mode and peripheral block information including picture type information for a peripheral block of the target block.

22. The apparatus of claim 21, further comprising a residual picture decoder for, if the block mode is a direct mode, receiving a residual picture corresponding to a differential picture between an original picture and the prediction picture, and restoring the original picture by adding the residual picture to the prediction picture.

23. The apparatus of claim 21, wherein the block mode includes at least one of a direct mode and a skip mode, and operations of the direct mode and the skip mode are determined depending on a picture type of the peripheral block.

24. The apparatus of claim 21, wherein the peripheral block information includes at least one of information indicating whether a mode, in which the peripheral block is coded, is an intra mode or an inter mode, and information indicating whether the peripheral block exists outside or inside a picture area.

25. The apparatus of claim 24, wherein the prediction picture generator fully fills the prediction picture with ‘0’ without performing motion compensation, if the block mode is a skip mode and the peripheral block information indicates the intra mode or indicates that the peripheral block exists outside the picture area.

26. The apparatus of claim 24, wherein the prediction picture generator fully sets a motion vector with ‘0’ and generates the prediction picture by performing bidirectional motion compensation, if the block mode is a direct mode and the peripheral block information indicates the intra mode or indicates that the peripheral block exists outside the picture area.
